(19) United States
(12) Patent Application Publication
(10) Pub. No.: US 2016/0372856 A1
(43) Pub. Date: Dec. 22, 2016

(54) PORT BLOCKER ASSEMBLY

(71) Applicant: ACCO Brands Corporation, Lake Zurich, IL (US)

(72) Inventors: William DeMeulenaere, Newark, CA (US); Mike Otsuka, Sunnyvale, CA (US); Brian Bautista, South San Francisco, CA (US); James Kao, Hayward, CA (US); Mark Brinkerhoff, Campbell, CA (US); Eric Aldenbrook, Campbell, CA (US)

(21) Appl. No.: 15/159,918

(22) Filed: May 20, 2016

Related U.S. Application Data
(60) Provisional application No. 62/180,817, filed on Jun. 17, 2015.

(51) Int. Cl. H01R 13/443; H01R 13/44

(52) U.S. Cl. CPC H01R 13/443; H01R 13/44

(57) ABSTRACT

A port blocker assembly for a port on an electronic device includes a body and a first lock finger movably coupled to the body. The first lock finger is configured to be inserted into the port. The port blocker assembly also includes a second lock finger movably coupled to the body. The second lock finger is configured to be inserted into the port. The port blocker assembly further includes a wedge positioned between the first and second lock fingers and movably coupled to the body. The wedge is movable between a first position, in which the first and second lock fingers are disengaged from the port, and a second position, in which the first and second lock fingers engage the port. The port blocker assembly also includes an actuator coupled to the wedge. The actuator is operable to move the wedge between the first and second positions.

### CROSS-REFERENCE TO RELATED APPLICATIONS

This application claims priority to U.S. Provisional Patent Application No. 62/180,817, filed Jun. 17, 2015, the entire contents of which are incorporated by reference herein.

### BACKGROUND

The present invention relates to port blockers for electronic devices, such as computers.

### SUMMARY

In one embodiment, the invention provides a port blocker assembly for a port on an electronic device. The port blocker assembly includes a body and a first lock finger movably coupled to the body. The first lock finger is configured to be inserted into the port. The port blocker assembly also includes a second lock finger movably coupled to the body. The second lock finger is configured to be inserted into the port. The port blocker assembly further includes a wedge positioned between the first and second lock fingers and movably coupled to the body. The wedge is movable between a first position, in which the first and second lock fingers are disengaged from the port, and a second position, in which the first and second lock fingers engage the port. The port blocker assembly also includes an actuator coupled to the wedge. The actuator is operable to move the wedge between the first and second positions.

Other aspects of the invention will become apparent by consideration of the detailed description and accompanying drawings.

### BRIEF DESCRIPTION OF THE DRAWINGS

FIG. 1 is a perspective view of a port blocker assembly and a key.

FIG. 2 is a perspective view of the port blocker assembly.

FIG. 3 is another perspective view of the port blocker assembly.

FIG. 4 is a plan view of the port blocker assembly with a body portion removed, the port blocker assembly being in a first position.

FIG. 5 is a plan view of the port blocker assembly with the body portion removed, the port blocker assembly being in a second position.

FIG. 6 is a perspective view of the port blocker assembly including a boot.

FIG. 7 is an exploded perspective view of the port blocker assembly and the boot.

FIG. 8 is a perspective view of the port blocker assembly attached to a port of an electronic device.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

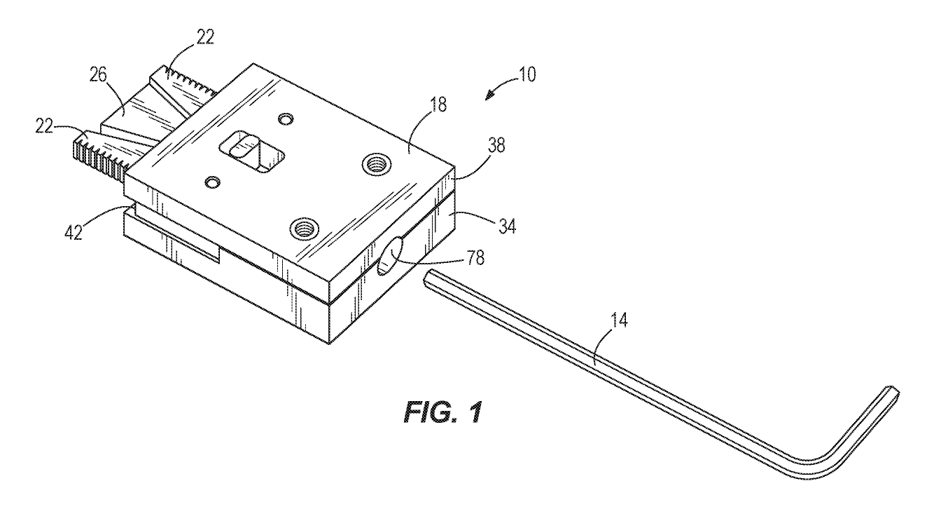

FIG. 1 illustrates a port blocker assembly 10. The port blocker assembly 10 is partially insertable into a port (e.g., a USB port) of an electronic device (e.g., a laptop computer) to block access to the port. The port blocker assembly 10 is secured to and unsecured from the port by a key 14. In the illustrated embodiment, the key 14 is a hex wrench. In other embodiments, the key 14 may have a non-conventionally-shaped end that is usable to secure and unsecure the port blocker assembly 10 from the port.

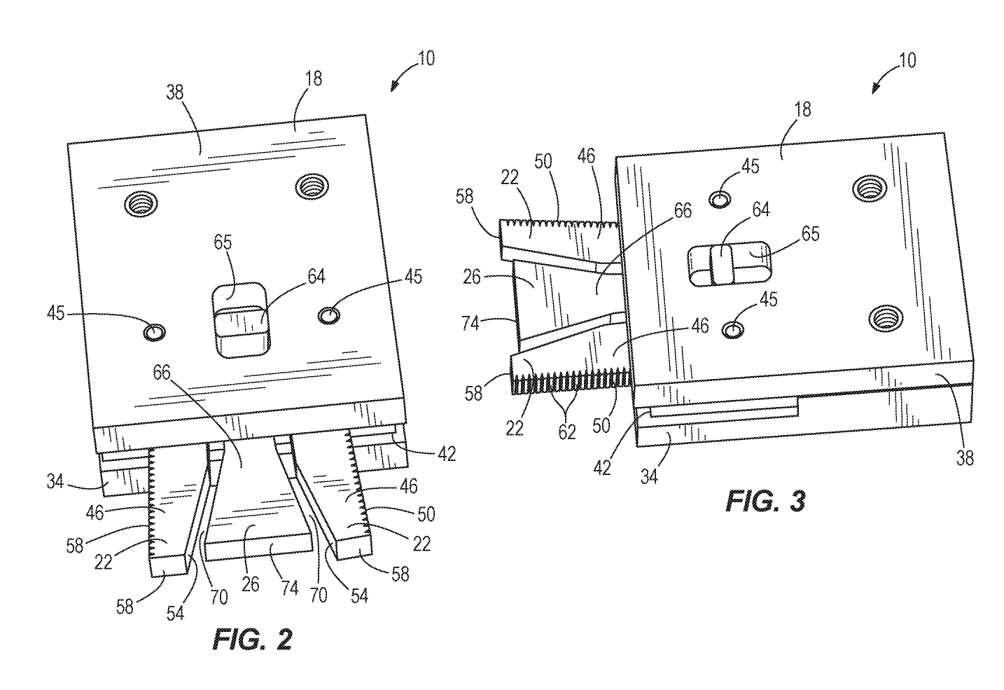

As shown in FIGS. 2-4, the illustrated port blocker assembly 10 includes a body 18, two lock fingers 22, a wedge 26, and an actuator 30. The body 18 supports and partially encloses the other components of the port blocker assembly 10. The body 18 includes two body halves 34, 38, or portions, that are secured together by fasteners, pins, welding, or the like. A slot 42 is defined between the two body halves 34, 38. The lock fingers 22 and the wedge 26 are partially received and captured within the slot 42.

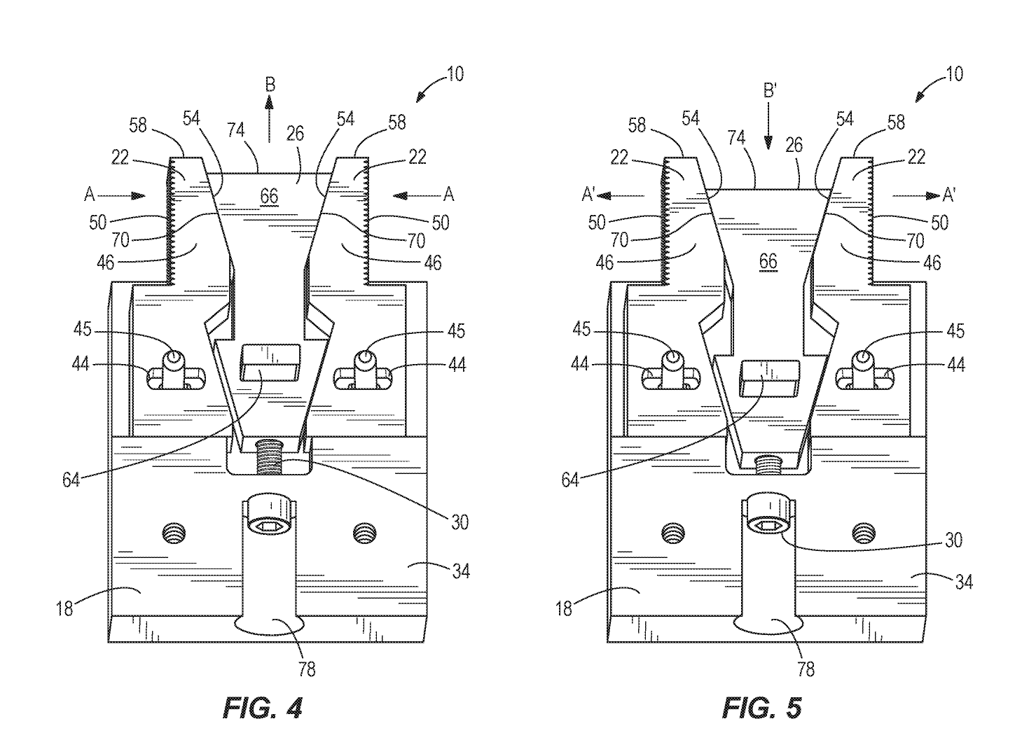

The lock fingers 22 are movably coupled to the body 18. The lock fingers 22 are movable (e.g., slidable) relative to the body 18 toward and away from each other. Each lock finger 22 includes an elongated slot 44 that receives a pin 45. The pins 45 extend between and are connected to the body halves 34, 38. The slots 44 and the pins 45 guide the lock fingers 22 for generally linear sliding movement in the direction of arrows A, A′ (FIGS. 4 and 5). In other embodiments, the lock fingers 22 may pivot relative to each other. In still further embodiments, the lock fingers 22 may be made of a suitable material to flex or end relative to each other.

Each lock finger 22 also includes an engagement portion 46 that extends outwardly from the slot 42 in the body 18. Each engagement portion 46 has a grip surface 50 and a ramped surface 54. The grip surfaces 50 are formed on outwardly-facing sides, or edges, of the lock fingers 22. The ramped surfaces 54 are formed on inwardly-facing sides, or edges, of the lock fingers 22. The ramped surfaces 54 are angled to form relatively narrow tips 58 at distal ends of the engagement portions 46. In the illustrated embodiment, each of the grip surfaces 50 includes a series of grooves 62 (FIG. 3) to help increase the gripping or engagement force of the lock fingers 22.

The wedge 26 is positioned between the lock fingers 22 and movably coupled to the body 18. The wedge 26 is movable (e.g., slidable) relative to the body 18 into and out of the body 18. The wedge 26 includes a projection 64 that is received in an elongated slot 65 formed in the body 18. The projection 64 and the slot 65 guide the wedge 26 for generally linear sliding movement in the direction of arrows B, B′ (FIGS. 4 and 5). In the illustrated embodiment, movement of the wedge 26 is in a direction that is generally perpendicular to movement of the lock fingers 22. In some embodiments, the body 18 may be covered or the elongated slot 65 may not extend entirely through the body 18 so that the projection 64 is not accessible from outside of the body 18.

The wedge 26 includes a flared portion 66 extending outwardly from the slot 42 in the body 18. The flared portion 66 includes two ramped surfaces 70 corresponding to the ramped surfaces 54 of the lock fingers 22. The ramped surfaces 70 of the wedge 26 contact the ramped surfaces 54 of the lock fingers 22 to move the lock fingers 22 relative to the body 18. The ramped surfaces 70 are angled to form a relatively wide tip 74 at a distal end of the wedge 26.

As shown in FIGS. 4 and 5, the actuator 30 is coupled to the wedge 26 to move the wedge 26 relative to the body 18. In the illustrated embodiment, the actuator 30 is a threaded fastener. The actuator 30 extends through an opening in the body 18 and threadably engages the wedge 26. The actuator 30 is rotatable to move the wedge 26 relative to the body. When the actuator 30 is rotated in a first direction, the actuator 30 threads into the wedge 26, pulling the wedge 26 into the body 18. When the actuator 30 is rotated in a second direction, the actuator 30 unthreads from the wedge 26, pushing the wedge 26 out of the body 18. The actuator 30 is rotatable by a user using the key 14 (FIG. 1) or other suitable tool. In the illustrated embodiment, the actuator 30 is accessible through a bore 78 formed in the body 18.

In operation, the wedge 26 is movable between a first, or extended, position (FIG. 4) and a second, or retracted, position (FIG. 5). When in the first position, the wedge 26 extends from the body 18 so that the wide tip 74 of the wedge 26 is generally in-line with the narrow tips 58 of the lock fingers 22. In this position, the lock fingers 22 are movable toward each other. In some embodiments, the lock fingers 22 may be biased toward each other by springs. Moving the lock fingers 22 toward each other (i.e., in the direction of the arrows A) decreases the distance between the grip surfaces 50 so that the lock fingers 22 are insertable into a port in an electronic device.

After the lock fingers 22 are inserted into the port, the wedge 26 is moved to the second position by rotating the actuator 30 in the first direction. As the actuator 30 is rotated, the wedge 26 is pulled into the body 18 (i.e., in the direction of arrow B′) so that the ramped surfaces 70 of the wedge 26 engage the ramped surfaces 54 of the lock fingers 22, pushing the lock fingers 22 away from each other (i.e., in the direction of arrows A′). Moving the lock fingers 22 away from each other increases the distance between the grip surfaces 50 so that the lock fingers 22 engage receptacle walls that define the port of the electronic device. In this position, the lock fingers 22 are spread apart to inhibit removal of the port blocker assembly 10 from the port.

To remove the port blocker assembly 10 from the port, the actuator 30 is rotated in the second direction. As the actuator 30 is rotated, the wedge 26 is pushed out of the body 18 (i.e., in the direction of arrow B) so that the wide tip 74 of the wedge 26 is moved generally in-line with the narrow tips 58 of the lock fingers 22. The lock fingers 22 can then move back toward each other (i.e., in the direction of arrows A). When the lock fingers 22 are moved toward each other, the port blocker assembly 10 can be removed from (e.g., pulled out of) the port in the electronic device.

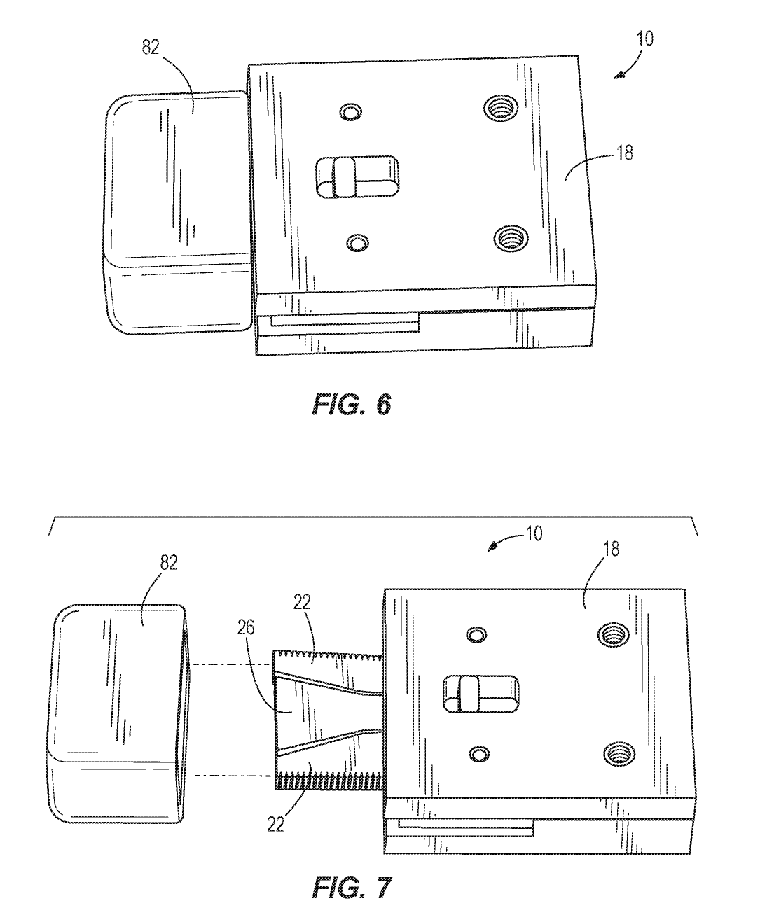

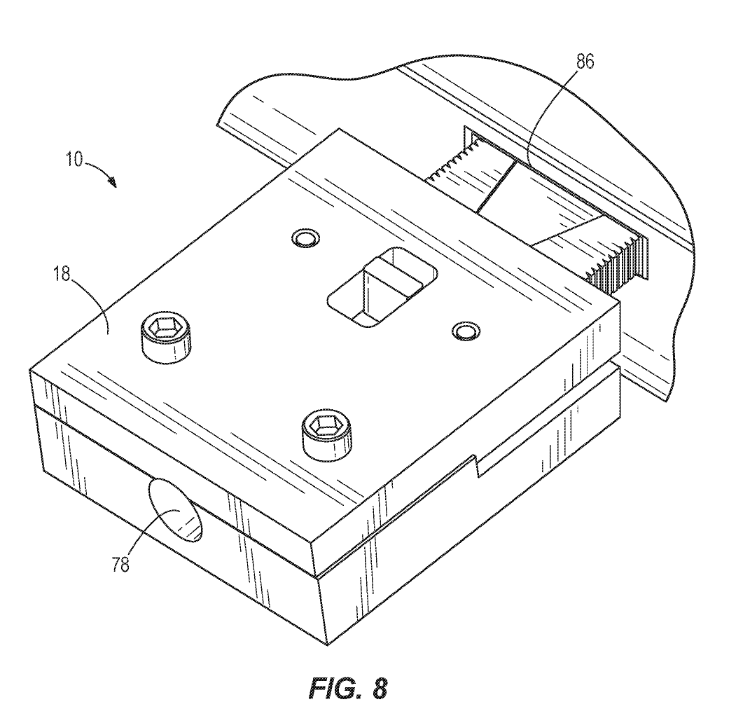

As shown in FIGS. 6 and 7, the illustrated port blocker assembly 10 also includes a boot 82. The boot 82 is a sleeve that is shaped and sized to fit over the engagement portions 46 of the lock fingers 22 and the flared portion 66 of the wedge 26. In the illustrated embodiment, the boot 82 is composed of rubber, although the boot 82 may also be made of other suitable materials.

The boot 82 is insertable into a port of an electronic device with the lock fingers 22. In the illustrated embodiment, the boot 82 is first positioned over the lock fingers 22 and then inserted into the port, although in other embodiments, the boot 82 may be inserted into the port before the lock fingers 22 are inserted into the boot 82. When the boot 82 is inserted into the port and the lock fingers 22 are moved away from each other, the lock fingers 22 push the boot 82 against the receptacle walls that define the port. The boot 82 increases the friction force between the lock fingers 22 and the receptacle walls to help retain the port blocker assembly 10 within the port. The friction force between the boot 82 and the receptacle walls is proportional to the outward force provided by the lock fingers 22. The grooves 62 on the grip surfaces 50 of the lock fingers 22 also increase the engagement force between the lock fingers 22 and the boot 82.

In some embodiments, the boot 82 is consumable. That is, after the port blocker assembly 10 is removed from the port, the boot 82 is also removed from the port and discarded. A new boot is used when the assembly 10 is re-installed in the port or installed in a different port. In other embodiments, the boot 82 may be used multiple times with the port blocker assembly 10.

FIG. 8 illustrates the port blocker assembly 10 connected to a port of an electronic device 86. In the illustrated embodiment, the port blocker assembly 10 is inserted into a type-A USB port. In other embodiments, the port blocker assembly 10 may be configured (e.g., shaped and sized) for insertion into type-B or type-C USB ports. In further embodiments, the port blocker assembly 10 may be configured for insertion into other types of computer ports (e.g., Ethernet ports, Firewire ports, Thunderbolt ports, etc.).

What is claimed is:

1. A port blocker assembly for a port on an electronic device, the port block assembly comprising:
a body;
a first lock finger movably coupled to the body, the first lock finger configured to be inserted into the port;
a second lock finger movably coupled to the body, the second lock finger configured to be inserted into the port;
a wedge positioned between the first and second lock fingers and movably coupled to the body, the wedge movable between a first position, in which the first and second lock fingers are disengaged from the port, and a second position, in which the first and second lock fingers engage the port; and
an actuator coupled to the wedge, the actuator operable to move the wedge between the first and second positions.

2. The port block assembly of claim 1, further comprising a rubber boot positioned around the first and second lock fingers, wherein the rubber boot is configured to be inserted into the port with the first and second lock fingers.
